(19) United States
(12) Patent Application Publication
(10) Pub. No.: US 2009/0012900 A1
(43) Pub. Date: Jan. 8, 2009

(54) Making Secure Data for Customer Loyalty Programs

(75) Inventors: Benjamin Morin, Rennes (FR); Sebastien Canard, Caen (FR); Fabrice Clerc, Blainville Sur Orne (FR)

Correspondence Address: COHEN, PONTANI, LIEBERMAN & PAVANE LLP, 551 FIFTH AVENUE, SUITE 1210, NEW YORK, NY, 10176, US

(73) Assignee: FRANCE TELECOM, Paris (FR)

(21) Appl. No.: 11/885,682

(22) PCT Filed: Mar. 2, 2006
(86) PCT No.: PCT/FR2006/050190

§ 371 Date: May 1, 2008

(30) Foreign Application Priority Data
Mar. 3, 2005 (FR) 0502144

(51) Int. Cl. H04L 9/00

(52) U.S. Cl. 705/64

(57) ABSTRACT

A portable device, a terminal, a system, and a method of storing data relating to transactions by terminals (1) of merchants in portable loyalty devices (3) of customers of at least one group comprising at least one merchant, said transaction being stored by the terminal (1) of said merchant in the portable device (3) by executing the following steps in any order: storing a first record corresponding to said transaction encrypted with an encryption key (C1) of the customer; and storing a second record corresponding to said transaction encrypted with a key (M1) associated with said group to which said merchant belongs.

### TECHNICAL FIELD OF THE INVENTION

The invention relates to the field of making computer data secure and in particular to the field of electronic and computer systems for encouraging loyalty of customers to at least one group comprising at least one merchant.

### BACKGROUND OF THE INVENTION

To encourage loyalty from their customers, merchants often use storage media able to record transactions with their customers in order for them to claim rewards. The amount and the nature of the rewards depend on the loyalty strategy adopted by the merchants and can be a function of a number of transactions, a cumulative total spend, etc.

Loyalty systems generally have in common a mechanism for recording some or all of the data linked to transactions between customers and a merchant. For example, this data can include a reference code for each item, a price for each item, the number of items, the total amount of the transaction, etc. This data is used to compute a reward offered to a customer.

The loyalty media or cards used to store the data are more or less sophisticated, ranging from a simple paper card, which is stamped by the merchant on the occasion of each transaction, to magnetic cards.

The transaction data can be stored by the merchants and/or on the customers' storage media.

If the transaction data is stored only by the merchants, the loyalty cards serve to identify the customers. The security of the loyalty system (in particular in terms of providing protection against fraud) is guaranteed by the security of the storage medium used by the merchants (for example a computer database). However, this approach has a number of drawbacks. First of all, this form of security does not protect customers against dishonest merchants, who could delete transactions, for example, to deprive their customers of the rewards due to them. Moreover, customers cannot check the status of their loyalty points whenever they wish. Finally, this approach makes it necessary for the merchant to implement a possibly complex loyalty infrastructure.

Conversely, storing transaction data on a medium held by the customer does not require the merchant to install a complex infrastructure, and means that customers can check the status of their loyalty points. However, since each merchant has their own loyalty card scheme, customers must necessarily hold a multitude of loyalty cards to benefit from offers. What is more, some storage media require the customer to memorize an access code (PIN).

From the security point of view, it is necessary to provide merchants with a guarantee as to the authenticity of the transaction data. With paper media, the use of a logo specific to a merchant and a stamp guarantee some degree of authentication, but these features are generally simple to counterfeit. With more sophisticated storage media (for example magnetic cards), the dissimulation of the data structures and/or the technical difficulties of committing fraud cannot guarantee sufficient security.

The electronic loyalty card concept has been the subject of research. For example, the patent FR 2 810 760 proposes a customer loyalty computer system comprising a plurality of merchant terminals and a plurality of loyalty cards issued to customers. The terminals include memory for storing a loyalty program and storage means for storing in the memory of loyalty cards data corresponding to commercial operations. However, that system does not offer sufficient security to provide merchants with a guarantee as to the authenticity of the transaction data.

The documents GB 2 397 678 and EP 0 992 924 propose secure loyalty card schemes but their security features relate only to the confidentiality of the data specific to the customers contained in the card and do not guarantee security against possible fraud by customers.

The document U.S. Pat. No. 6 654 9912 proposes a file structure for storing transactions on any type of loyalty card (mobile telephone, smart card, etc.). Only the confidentiality of transactions is referred to, which is ensured by means of passwords stored directly on the card by the merchant. Transactions are therefore accessible only to the merchant.

Rather than a secure loyalty card scheme, the document FR 2 804 228 merely proposes a method of displaying information contained in a loyalty card to enable a customer to determine the status of their privileges with the merchants.

The invention therefore consists in a method of storing data relating to transactions by terminals of merchants in portable loyalty devices of customers of at least one group comprising at least one merchant, a transaction being stored by a merchant terminal in a portable device by executing the following steps in any order:
storing a first record corresponding to said transaction encrypted with an encryption key of the customer; and
storing a second record corresponding to said transaction encrypted with an encryption key associated with said group to which said merchant belongs.

Thus the method of the invention enables a customer to use the same portable loyalty device securely and universally with more than one merchant belonging to one or more groups. The first record guarantees that only the customer has access to all the transactions and the second record guarantees that only merchants belonging to the same group can decrypt transactions of the customer with one of their partners.

The method advantageously includes signing said transaction with a private electronic signature key associated with said merchant.

Thus signing the transaction guarantees the authenticity, integrity and non-repudiation of transactions.

Said first record can be decrypted by means of a decryption key of the customer and said second record can be decrypted by means of said encryption key associated with said group to which said merchant belongs.

Said data relating to the transaction advantageously includes one or more of the following:
an identifier of the transaction for preventing accumulation of rewards already awarded to the customer;
an identifier of the customer for preventing a third party enjoying rewards illegitimately;
an identifier of the group of merchants for guaranteeing the universality of the loyalty scheme;
an amount of the transaction for effecting loyalty operations as a function of the total amount spent by a customer with a merchant;
a date of the transaction for effecting time-limited rewards;
a marker for indicating that the customer has already enjoyed rewards resulting from the transaction, or that the transaction has not been invoiced, or that the transaction has been cancelled; and
a product identifier for organizing loyalty operations as a function of particular products.

Thus merchants and customers are protected against fraud perpetrated by dishonest merchants or dishonest customers. Furthermore, depending on the marking of the transaction, the portable loyalty device can be used as an electronic special offer price or a reliable receipt, in addition to its use as a loyalty card.

The invention also consists in a method of reading secure data relating to transactions recorded by means of a method of recording secure data having the above features, the reading method including the following steps:
decrypting said secure data by means of the encryption key associated with said group to which said merchant belongs; and
verifying the authenticity of said transactions by means of the public signature key.

According to one particular aspect of the invention, the data relating to transactions stored in the portable loyalty device is fed into a specific loyalty computer program which, following its execution, returns information relating to the rewards awarded to the customer for those transactions.

Thus a merchant who participates in several different partnerships can choose the loyalty program appropriate to given transactions.

The invention also consists in a computer system for storing data relating to a transaction by terminals of merchants in portable loyalty devices of customers of at least one group comprising at least one merchant, the merchant terminals being adapted to store the data of said transactions in storage means of the portable devices via a first communication channel and using a data structure including:
a first record corresponding to said transaction encrypted with an encryption key of the customer; and
a second record corresponding to said transaction encrypted with an encryption key associated with said group to which said merchant belongs.

Thus the loyalty system according to the invention has a universal character and security features.

Said data structure advantageously includes a signature of said transaction by a private electronic signature key associated with said merchant.

Thus the system includes authenticity features of benefit to merchants and customers.

The system advantageously includes a device for storing an identifier of said merchant and their public and private electronic signature keys, which the terminal of said merchant accesses via a second communication channel.

Thus the identifier and the public and private signature keys can be stored in a simple, secure and non-modifiable manner.

The system further includes a storage medium for storing encryption keys shared by the members of the group to which said merchant belongs connected to the terminal via a third communication channel.

Thus the encryption keys can be shared in a simple and secure manner between several merchants belonging to the same group.

The system can further include a key distributor for distributing said encryption keys via a fourth communication channel.

Thus the encryption keys can be distributed in a confidential and centralized manner to all the merchants.

The system can further include a server for storing the transaction and/or the encrypted coordinates of the customer, connected to the terminal via a fifth communication channel.

Thus the transaction is made more secure by an additional record and customer coordinates can be used in a secure and centralized manner for market research or advertising campaigns.

The system can further include a loyalty program distributor connected to the terminal via a sixth communication channel.

Thus the loyalty programs can be distributed in a uniform and centralized manner to each group of merchants in accordance with the loyalty structure adopted by each group.

The invention also consists in a portable loyalty device for a loyalty computer system having the above features and including cryptographic computation means and storage means for storing the data relating to said transaction.

Thus the portable loyalty device makes deployment of the loyalty system very simple for the customer and the merchant alike.

The device further includes a read-only memory for storing an identifier of the customer and public and private encryption keys of the customer and the storage means further contain personal data of the customer stored in a form encrypted with the public encryption key associated with the customer so that access to this personal data is subject to authorization by said customer by means of a personal identification number.

Thus the identifier and the public and private encryption keys of the customer are stored in a simple, secure and non-modifiable manner and the personal data of the customer is protected.

By marking information included in the transaction record, the device can advantageously be used as a loyalty card, as a receipt or to record electronically a special offer price.

Thus the loyalty device guarantees the authenticity of and non-repudiation of an offer and a reliable receipt.

The invention also consists in a terminal for storing data relating to transactions in portable loyalty devices of customers of at least one group comprising at least one merchant, characterized in that said data is stored in a data structure including:
a first record corresponding to said transaction encrypted with an encryption key of the customer;
a second record corresponding to said transaction encrypted with an encryption key associated with said group to which said merchant belongs.

Said data structure advantageously includes a signature of said transaction by a private electronic signature key associated with said merchant.

The invention also consists in a computer program downloadable from a communication network and/or stored in a computer-readable medium and/or executable by a microprocessor, characterized in that it includes program code instructions for executing steps of a storage method having one or more of the above features when it is executed in a computer or a microprocessor.

### BRIEF DESCRIPTION OF THE DRAWINGS

Other features and advantages of the invention emerge from a reading of the description given below by way of non-limiting example and with reference to the appended drawings, in which:

FIG. 1 illustrates a highly-schematic example of a loyalty system in accordance with the invention, including a terminal and a portable loyalty device; and

FIG. 2 illustrates the loyalty system from FIG. 1 further including a server and key and loyalty program distributors.

### DETAILED DESCRIPTION OF EMBODIMENTS

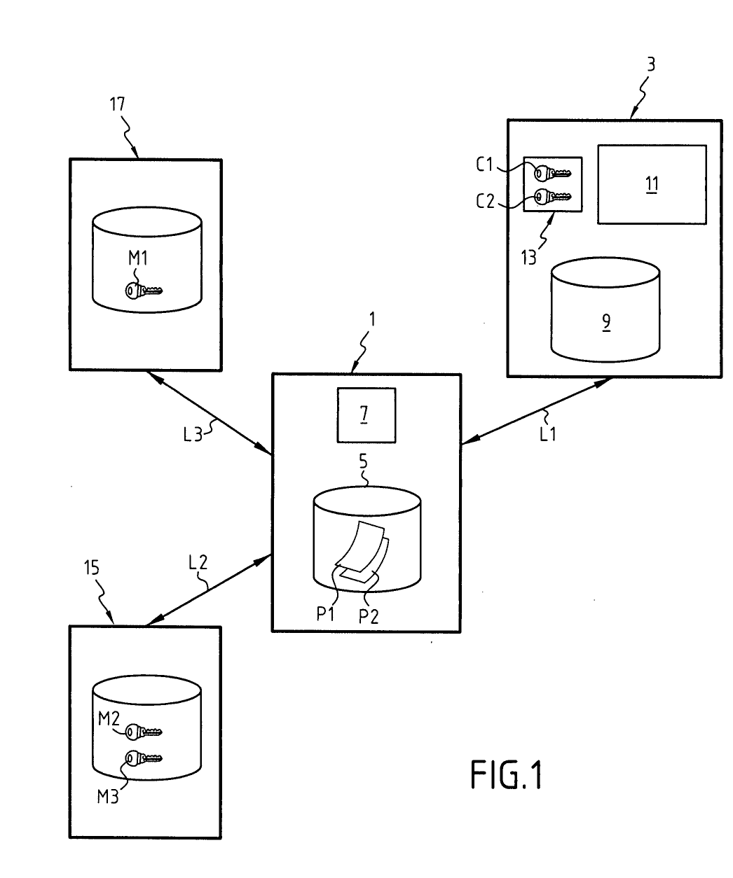

FIG. 1 illustrates a highly-schematic example of a computer system according to the invention for storing data relating to transactions by the terminals of merchants on portable loyalty devices of customers of at least one group comprising at least one merchant. The loyalty system is valid for a plurality of groups and each group is defined by a particular partnership between a plurality of merchants. Thus a partnership is a loyalty operation organized by a group of merchants whereby customers receive rewards valid with all the merchants of that group. Such a partnership can exist between a hairdresser and a vendor of beauty products, for example. Naturally the invention also takes into account partnerships whereby merchants trade under the same name. This enables a customer to receive rewards from separate merchants who trade under the same name.

Of course, a merchant can be a member of various separate groups and a group may consist of only one merchant.

The loyalty computer system of the invention includes a plurality of electronic terminals 1 used by merchants and a plurality of portable loyalty devices 3 used by customers.

The electronic terminal 1 of a merchant belonging to said at least one group includes a memory 5 for storing at least one loyalty program P1, P2 and reading, writing and processing means 7 for executing the loyalty programs P1, P2. A loyalty program is a computer program that delivers information relating to a reward awarded to a customer as a function of transactions effected by the customer with a merchant.

Thus the loyalty program employs a loyalty strategy specific to the merchant or group of merchants in accordance with a set of rules defining conditions for receiving rewards, their nature and their amount (for example 5% of the spend on the last ten purchases, a free gift after five purchases, etc.). A loyalty strategy is a function of several parameters, such as a number of transactions, a cumulative transaction amount or a transaction validity period.

Of course, a terminal 1 can execute a plurality of loyalty programs P1, P2 so that a merchant participating in a plurality of separate partnerships can choose the loyalty strategy appropriate to a given transaction, for example.

The reading, writing and processing means 7 in the electronic terminal 1 of a merchant store transactions between the merchant and customers in storage means 9 of the portable loyalty devices 3 of the customers. The portable loyalty device 3 interacts with the terminal 1 of the merchant via a first communication channel L1 that can be an electrical, magnetic, optical, radio, infrared or other channel.

Data relating to each transaction is stored in a secure data structure including a first encrypted record of the transaction and a second encrypted record of the transaction and advantageously including a signature of the transaction.

The first record corresponds to the transaction encrypted with a public encryption key C1 of the customer, the second record corresponds to the transaction encrypted with a symmetrical encryption key M1 associated with the group to which the merchant belongs, and the transaction is signed using a private electronic signature key M2 associated with the merchant.

The first record can be decrypted by means of a private decryption key C2 of the customer, the second record can be decrypted by means of the symmetrical encryption key M1, and the signature can be verified by means of a public key M3 corresponding to the private electronic signature key M2.

The encryption of the transaction using the key C1 guarantees that only the customer has access to all their transactions, which they can decrypt using their secret key C2. The encryption of the transaction using the key M1 guarantees that only merchants belonging to the same group can decrypt transactions of the customer with one of their partners (and only those transactions). Finally, signing the transaction guarantees the authenticity of the transaction, i.e. that a dishonest customer cannot forge an imaginary transaction.

The transaction can moreover be considered as an n-tuple data set that can include an identifier of the merchant (or of the group of merchants in the context of a partnership), an identifier of the customer, a transaction identifier, a product identifier, a transaction amount, a transaction date, and a marker.

The merchant identifier uniquely identifies the merchant (or the group of merchants) and therefore guarantees the universal nature of the portable loyalty device 3.

The customer identifier uniquely identifies the proprietor of the portable loyalty device 3. The presence of the customer identifier in each transaction prevents a customer transferring their rewards fraudulently to a third party. The customer identifier in each transaction recorded in the portable device 3 must be the same as that of the proprietor of the portable device 3. This can be verified by the merchant when a customer claims a reward.

For example, the function of the transaction identifier is to prevent a customer from forging imaginary purchases by duplicating transaction records. The transactions stored in the portable loyalty device 3 must differ at least in terms of their transaction identifier, and a fraud can therefore be identified by the existence of two identical transactions. The transaction identifier can be a value assigned by the terminal 1 of the merchant at the time of the transaction. This value can be managed by a counter incremented on each transaction (optionally depending on the identity of the customer).

Alternatively, the transaction identifier can be replaced by a number of units of the same product. A fraud is then identified by the existence of multiple transactions for the same product at the same time. The transaction identifier therefore prevents accumulation of rewards already awarded to the customer.

The presence of the amount of a transaction provides for loyalty operations that award customers rewards as a function of the total amount spent by the customer with a merchant. The portable loyalty device 3 naturally takes charge of rewards that are a function of the number of transactions.

The presence of the date of the transaction provides for time-limited rewards.

The identifier of a product or a service means that loyalty operations linked to particular products can be organized. The identifier may be a number present in the product's bar code, for example, or a descriptive character string. It should be noted that the presence of the identifier of the merchandise does not make the presence of the amount superfluous. The price of merchandise can change over time. Moreover, if the transaction amount were to be based only on the identifier of the merchandise, merchants would be obliged to use a complex infrastructure to store the history of the evolution of the price of each item.

The function of the marker is to indicate transactions that have been used by a customer to claim rewards. Its presence in transactions prevents a customer from modifying their transactions illegitimately to claim rewards more than once.

The marker can also be used to mark transactions that are special offer prices (i.e. have not yet been invoiced) and transactions that have been cancelled. The meaning of the marker can be indicated by a table of codes (for example: 0=reward claimed, 1=special offer price, 2=transaction cancelled). Thus according to the transaction marker, the portable loyalty device 3 can reliably be used as an electronic special offer price or a receipt, over and above its use as a loyalty card.

Each customer must have a portable loyalty device 3 fitted with a chip capable of effecting cryptographic calculations that provide the security features of the loyalty system. Thus over and above the storage means 9 for storing records of transactions, the portable loyalty device 3 includes cryptographic computation means 11 and memory means (for example a read-only memory 13) for non-modifiable storage of the public and private encryption keys C1, C2 and the identifier of the customer.

It should further be noted that the storage means 9 can also contain personal data of the proprietor of the portable loyalty device 3 encrypted using their public key C1. Access to this data is therefore subject to authorization by the customer, for example by means of a personal identification number (PIN).

The portable loyalty device 3 can be a smart card, a mobile telephone, a personal digital assistant or any other type of equipment including cryptographic computation means and storage means.

It should be noted that if the portable loyalty device 3 is a smart card, the terminal 1 must be equipped with a card reader. However, if the portable loyalty device 3 is a mobile telephone, the terminal 1 can be equipped with a Bluetooth-type peripheral, for example, so it can communicate with the portable device 3.

The chip of the portable loyalty device 3 advantageously includes (physical or logical) protection means entitling the customer only to read the transaction storage means 9 and preventing the merchant from deleting data contained in the transaction storage means 9.

In one particular embodiment of the invention, the customer cannot modify data written in the transaction storage means 9 if each item of data (a new transaction or an reward claimed) is numbered and the merchant stores the number of the last data item written for each customer. Using this mechanism, another particular embodiment of the invention requires the customer to sign each of the transactions written by the merchant by means of an electronic signature key, thus preventing the merchant from fraudulently deleting data.

The loyalty system further includes an integrated circuit device 15 (for example a smart card) that the terminal 1 of a merchant accesses via a second communication channel L2 (cable, optical, radio, infrared, magnetic, etc. reader). This integrated circuit device 15 is adapted to store in a secure and non-modifiable manner the public and private electronic signature keys M2, M3 and the identifier of the merchant (or group of merchants).

The loyalty system further includes a secure storage medium 17 for storing the symmetrical encryption keys M1 shared by the groups to which the merchant belongs connected to the terminal 1 of a merchant via a secure third communication channel L3.

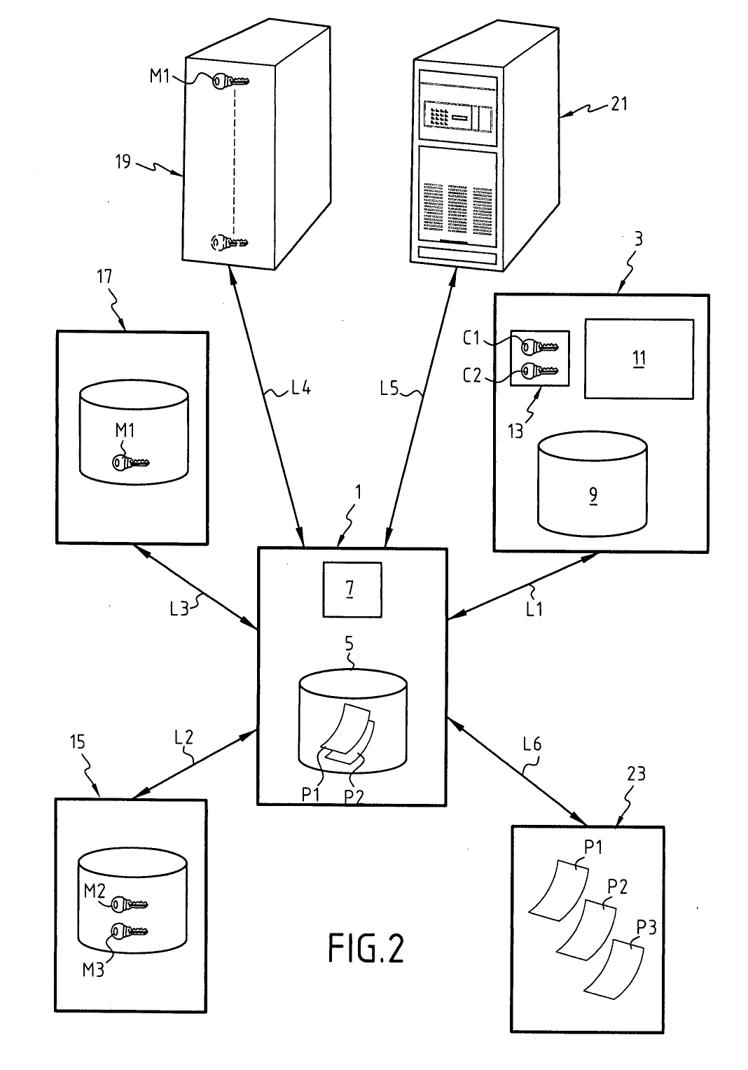

FIG. 2 shows that the loyalty system can further include a key distributor 19 for distributing symmetrical encryption keys M1 via a fourth communication channel L4. In this embodiment, with partnerships or merchants trading under the same name, encryption keys are distributed by this confidential key distributor 19 via any secure communication channel.

Alternatively, the electronic terminal 1 of one of the members of a group of merchants includes production means (not shown) for generating a symmetrical encryption key M1 and then sending it securely to the other members of the partnership. Another option is conjoint and secure computation of the symmetrical encryption key M1 by all the members of the group of merchants.

In one particular embodiment of the invention, the terminal 1 of the merchant can be connected via a secure fifth communication channel L5 to a server 21 for storing transactions and where applicable customer coordinates. Those coordinates, which are provided by the customer, are communicated in an encrypted manner and access thereto is subject to the agreement of the customer, by means of a PIN. Customers' coordinates can be used for personalized market research or advertising campaigns.

The loyalty system further includes a distributor 23 of programs P1, P2, P3 connected to the terminal 1 via a sixth communication channel L6 and adapted to distribute loyalty programs that are loaded into the memory of the terminal 1. Where appropriate, the same entity can implement the encryption key distribution and loyalty program distribution functions.

The loyalty programs P1, P2, P3 are executed on each transaction at the request of a customer seeking to claim its rewards or at the initiative of the merchant.

The parameters necessary for implementing any loyalty strategy can consist only of the data stored in the portable loyalty device 3.

For a customer to claim a reward at the time of one or more transactions, the merchant executes a loyalty program loaded into their terminal 1. The valid transactions stored in the portable loyalty device 3 are supplied as input to this specific loyalty program which, after it is executed, returns information relating to the rewards awarded to the customer for those transactions.

The loyalty program obtains the transactions effected with the merchant or one of their partners by decrypting the records stored in the portable device 3 using the symmetrical encryption key M1 of the merchant. It then verifies the authenticity of the transactions using the public electronic signature key M3 of the merchant. After this verification, the loyalty program selects the valid transactions, i.e. those that have not been marked as having been already used by the customer in order to claim a reward. The valid transactions for which the customer wishes to enjoy a reward are supplied as input parameters to the program that implements the loyalty strategy and in return gives the amount of the reward. New transactions are encrypted, signed and stored in the portable loyalty device 3, and where applicable earlier transactions used to claim the reward are marked, encrypted and signed.

By way of example, consider a merchant applying a loyalty strategy that offers its customers a reduction equal to 20% of cumulative spending within the last year. The reduction is applied to the price of an item chosen by the customer (this 20% cannot exceed the price of the item in question).

It is assumed that the merchant has previously downloaded into their terminal 1 the loyalty programs P1, P2, P3 implementing this strategy.

Consider now a customer who has already purchased three items from this merchant in the last six months. At the time of purchasing a fourth item, the customer wishes to claim the reward to which they are entitled. The customer hands their portable loyalty device 3 to the merchant. The merchant's terminal 1 attempts to decrypt each of the transactions in the portable loyalty device 3 using only the symmetrical encryption key M1 of the merchant, because the loyalty strategy applies only to purchases from this merchant (if the merchant had been a partner of other merchants, the terminal would have used the appropriate encryption key, as indicated by the merchant).

The merchant's terminal then verifies the authenticity of the transactions using the merchant's public signature key M3 and a signature verification protocol.

The next step of the terminal 1 is to select the transactions “eligible” for computing the reward, in this instance spending within the last year not already used to claim a reward. Once this list of transactions has been extracted, the terminal 1 computes 20% of the total spend.

Once the discount has been given on the new item, the three items used to claim the reward are marked as invalid to prevent the customer using them again subsequently. These modifications are encrypted and signed.

In its turn, the signed and encrypted new purchase is stored in the portable loyalty device 3.

Remember that transactions are stored in two versions. One version corresponds to transactions encrypted with a customer's public key to enable customers to consult all their purchases. The other version corresponds to the transaction encrypted with an encryption key selected by the merchant (their own or one shared with partners within the same group).

The customer can at any time consult all the transactions stored in the portable loyalty device 3. Thus a customer can consult the rewards that they can claim before visiting a merchant.

For example, the customer may have a display terminal available for accessing and displaying the transactions stored in their portable loyalty device 3. At the request of the display terminal, and after authorization by the customer, for example by means of a PIN, the portable loyalty device 3 decrypts the transactions previously encrypted using the customer's public key and sends them to the display terminal, which displays them.

If the portable loyalty device 3 is a mobile telephone, it can also serve as the terminal. If the portable loyalty device 3 is a smart card, a dedicated display terminal is necessary, for example a peripheral connected to a personal digital assistant or a personal computer or a card reader provided with a screen.

If the portable loyalty device 3 is used to store electronically a special offer price, the customer goes to a first merchant. The merchant signs and encrypts a special offer price (a transaction) for a specific item or service. That item or service is marked as not yet invoiced, in order for a customer not to be able fraudulently to pass off a special offer price for a transaction that has been completed. The special offer price is finally stored in the portable loyalty device 3. The customer can thus prove the authenticity of an offer by a competing merchant. To this end, the customer consults the offer made by the first merchant with the aid of their display terminal and presents it to the second merchant. Thus the electronically stored special offer price guarantees to merchants the authenticity of competing offers made to customers during a negotiation and guarantees to customers non-repudiation of an offer made by a merchant.

Moreover, to use the portable loyalty device 3 as a reliable electronic receipt, the customer offers their portable loyalty device 3 to a merchant to whom they wish to return an item, for example. As with a purchase, the merchant's terminal 1 accesses the transactions stored in the customer's portable loyalty device 3. The merchant is sure of the authenticity of those purchases because they signed them at the time of the transaction. If the merchant accepts the returned item, the transaction is marked as cancelled. Thus the electronic receipt guarantees to merchants the authenticity of their own identity in transactions stored in the portable loyalty device 3 and guarantees to customers non-repudiation of a purchase by a dishonest merchant.

Thus the prevent invention proposes a universal loyalty method, system and device for implementing any loyalty strategy. The use of portable loyalty devices retained by customers greatly simplifies deployment, as much for the customer as for the merchant. Merchants require only a terminal able to read transactions stored in the customer's device, which can take the form of a smart card, a mobile telephone or any other secure mobile device, for example.

Furthermore, the mobile loyalty device can also be used as a receipt or to store a special offer price.

Moreover, every transaction has security features (authentication of purchases, non-accumulation of rewards, non-repudiation of transactions by a merchant, confidential transactions and confidential personal data), thus protecting both merchants and customers against fraud.

It should be noted that the steps of the storage method of the invention can be executed by code instructions of a computer program when it is executed on a computer or a microprocessor. This computer program can be downloaded from a communication network and/or stored on a computer-readable medium.

1. A method of storing data relating to transactions by terminals (1) of merchants in portable loyalty devices (3) of customers of at least one group comprising at least one merchant, wherein a transaction is stored by a merchant terminal (1) in a portable device (3) by executing in any order the steps of:
storing a first record corresponding to said transaction encrypted with an encryption key (C1) of the customer; and
storing a second record corresponding to said transaction encrypted with an encryption key (M1) associated with said group to which said merchant belongs.

2. The method according to claim 1, comprising signing said transaction with a private electronic signature key (M2) associated with said merchant.

3. The method according to claim 1, wherein said first record can be decrypted by means of a decryption key (C2) of the customer and said second record can be decrypted by means of said encryption key (M1) associated with said group to which said merchant belongs.

4. The method according to claim 1, wherein said data relating to the transaction includes one or more of the following:
an identifier of the transaction for preventing accumulation of rewards already awarded to the customer;
an identifier of the customer for preventing a third party enjoying rewards illegitimately;
an identifier of the group of merchants for guaranteeing the universality of the loyalty scheme;
an amount of the transaction for effecting loyalty operations as a function of the total amount spent by a customer with a merchant;
a date of the transaction for effecting time-limited rewards;
a marker for indicating that the customer has already enjoyed rewards resulting from the transaction, or that the transaction has not been invoiced, or that the transaction has been cancelled; and
a product identifier for organizing loyalty operations as a function of particular products.

5. The method of reading secure data relating to transactions recorded by means of a method according to claim 1, comprising the steps of:
decrypting said secure data by means of said encryption key (M1) associated with said group to which said merchant belongs; and
verifying the authenticity of said transactions by means of a public signature key (M3).

6. The method according to claim 5, wherein the data relating to transactions stored in the portable loyalty device (3) is fed into a specific loyalty computer program which, following its execution, returns information relating to the rewards awarded to the customer for those transactions.

7. A computer system for storing data relating to transactions by terminals (1) of merchants in portable loyalty devices (3) of customers of at least one group comprising at least one merchant, wherein the merchant terminals (1) are adapted to store the data of said transactions in storage means (9) of the portable devices (3) via a first communication channel (L1) and using a data structure including:
a first record corresponding to said transaction encrypted with an encryption key (C1) of the customer; and
a second record corresponding to said transaction encrypted with an encryption key (M1) associated with said group to which said merchant belongs.

8. The system according to claim 7, wherein said data structure includes a signature of said transaction by a private electronic signature key (M2) associated with said merchant.

9. The system according to claim 7, comprising a device (15) for storing an identifier of said merchant, their private electronic signature key, and a public electronic signature key, which device the terminal (1) of said merchant accesses via a second communication channel (L2).

10. The system according to claim 5, further comprising a storage medium (17) for storing encryption keys (M1) shared by the members of the group to which said merchant belongs connected to the terminal (1) via a third communication channel (L3).

11. The system according to claim 10, comprising a key distributor (19) for distributing said encryption keys (M1) via a fourth communication channel (L4).

12. The system according to claim 7, further comprising a server (21) for storing the transaction and/or the encrypted coordinates of the customer, connected to the terminal via a fifth communication channel (L5).

13. The system according to claim 7, further comprising a loyalty program distributor (23) connected to the terminal via a sixth communication channel (L6).

14. A portable loyalty device (3) for a loyalty computer system according to claim 7, comprising cryptographic computation means (11) and storage means (9) for storing the data relating to said transaction.

15. The device according to claim 14, comprising a read-only memory (13) for storing an identifier of the customer and public and private encryption keys (C1, C2) of the customer, and wherein the storage means (9) further contain personal data of the customer stored in a form encrypted with the public encryption key (C1) associated with the customer so that access to this personal data is subject to authorization by said customer by means of a personal identification number.

16. The device according to claim 14, wherein, by marking information included in the transaction record, said device is used as a loyalty card, as a receipt or to record electronically a special offer price.

17. A portable loyalty device (3) for customers of at least one group comprising at least one merchant, comprising storage means (9) for storing data relating to a transaction including:
a first record corresponding to said transaction encrypted with an encryption key (C1) of the customer; and
a second record corresponding to said transaction encrypted with an encryption key (M1) associated with said group to which said merchant belongs.

18. The device according to claim 17, wherein said data includes a signature of said transaction by a private electronic signature key (M2) associated with said merchant.

19. A terminal (1) for storing data relating to transactions in portable loyalty devices (3) of customers of at least one group comprising at least one merchant, wherein said storage is effected in a data structure including:
a first record corresponding to said transaction encrypted with an encryption key (C1) of the customer; and
a second record corresponding to said transaction encrypted with an encryption key (M1) associated with said group to which said merchant belongs.

20. The terminal according to claim 19, wherein said data structure includes a signature of said transaction by a private electronic signature key (M2) associated with said merchant.

21. A computer program downloadable from a communication network and/or stored in a computer-readable medium and/or executable by a microprocessor, comprising program code instructions for executing steps of the method according to claim 1 when the computer program is executed in a computer or a microprocessor.
